(19) United States
(12) Patent Application Publication
(10) Pub. No.: US 2007/0074251 A1
(43) Pub. Date: Mar. 29, 2007

(54) Method and apparatus for using random field models to improve picture and video compression and frame rate up conversion

(76) Inventors: Seyfullah Halit Oguz, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(21) Appl. No.: 11/509,213

(22) Filed: Aug. 23, 2006

Related U.S. Application Data
(60) Provisional application No. 60/772,158, filed on Feb. 10, 2006.
(60) Provisional application No. 60/721,374, filed on Sep. 27, 2005.

(51) Int. Cl. H04N 5/445; G06F 3/00; G06F 13/00

(52) U.S. Cl. 725/45; 725/46

(57) ABSTRACT

A method and apparatus for processing multimedia data comprising segmenting data into a plurality of partitions, assigning each of the plurality of partitions to one of a plurality of categories comprising a first category and a second category, encoding the plurality of partitions assigned to the first category using an algorithm and encoding the plurality of partitions assigned to the second category using a texture model. A method and apparatus for processing multimedia data comprising decoding a plurality of first partitions belonging to a first category using an algorithm, decoding a plurality of second partitions belonging to a second category using a texture model and creating multimedia data using boundary information, the plurality of first partitions and the plurality of second partitions.

### CLAIM OF PRIORITY UNDER 35 U.S.C. §119

The present Application for patent claims priority to Provisional Application No. 60/721,374 entitled “EA-FRUC IDF DRAFT DOCUMENT REGARDING THE USE OF MARKOV RANDOM FIELD MODELS,” filed Sep. 27, 2005 and to Provisional Application No. 60/772,158 entitled “SYSTEM AND METHOD FOR USING RANDOM FIELD MODELS TO IMPROVE PICTURE AND VIDEO COMPRESSION AND FRAME RATE UP CONVERSION,” filed Feb. 10, 2006, both of which are assigned to the assignee hereof and hereby expressly incorporated by reference herein.

### BACKGROUND

1. Field

The invention relates to picture and video compression. More particularly, the invention relates to methods and apparatus for using random field models to improve picture and video compression and frame rate up conversion.

2. Background

Digital products and services such as digital cameras, digital video recorders, satellite broadcast digital television (DTV) services and video streaming are becoming increasingly popular. Due to the limitations in digital data/information storage capacities and shared transmission bandwidths, a greater need has arisen to compress digital pictures and video frames for the efficient storage and transmission of digital pictures and video frames. For these reasons, many standards for the encoding and decoding of digital pictures and digital video signals have been developed. For example, the International Telecommunication Union (ITU) has promulgated the H.261, H.262, H.263 and H.264 standards for digital video encoding. Also, the International Standards Organization (ISO) through its expert study group Motion Picture Experts Group (MPEG) has promulgated the video compression related parts of the standards MPEG-1, MPEG-2 and MPEG-4 for digital video encoding. For example, MPEG-2 Video is currently the standard encoding technique used for digital television broadcast over satellite, terrestrial or cable transmission links. In the field of digital picture compression, the Joint Photographic Experts Group (JPEG), jointly established between ISO and ITU, has promulgated the JPEG and JPEG 2000 standards.

These standards specify the syntax of encoded digital video signals and how these signals are to be decoded for presentation or playback. However, these standards permit various different techniques (e.g., algorithms or compression tools) to be used in a flexible manner for transforming the digital video signals from an uncompressed format to a compressed or encoded format. Hence, many different digital video signal encoders are currently available. These digital video signal encoders are capable of achieving varying degrees of compression at varying quality levels. The compression techniques provisioned by contemporary standards and employed by current encoders are most suitable for the compression of non-textured objects and images.

Pictures and video frames, however, often include textured visual objects and regions that exhibit considerable detail across a multitude of scales. Examples of these objects include grass, flowers, leaves, water, and so on. In conjunction with slight changes in illumination conditions and/or small amounts of motion (i.e., position change), the precise fine details of these objects vary although their higher-level impression stays the same. Each of these objects can be referred to as a texture, which can be considered a stochastic, possibly periodic, two-dimensional pixel field (e.g., a portion of a picture or video frame) that shows rapid variations in terms of brightness (Y) and/or color (U, V) in small spatial neighborhoods (e.g., within a few pixels). The above compression algorithms are not very efficient at compressing textures.

For these reasons as well as others, a need exists for methods and systems for the efficient compression of visual objects and regions that include texture.

### SUMMARY

A method of processing multimedia data comprising segmenting data into a plurality of partitions, assigning each of the plurality of partitions to one of a plurality of categories comprising a first category and a second category, encoding the plurality of partitions assigned to the first category using an algorithm and encoding the plurality of partitions assigned to the second category using a texture model.

An apparatus for processing multimedia data comprising a segmenting module configured to segment data into a plurality of partitions, an assignment module configured to assign each of the plurality of partitions to one of a plurality of categories comprising a first category and a second category and an encoder configured to encode the plurality of partitions assigned to the first category using an algorithm and the plurality of partitions assigned to the second category using a texture model.

A method of processing multimedia data comprising decoding a plurality of first partitions belonging to a first category using an algorithm, decoding a plurality of second partitions belonging to a second category using a texture model and creating multimedia data using boundary information, the plurality of first partitions and the plurality of second partitions.

An apparatus for processing multimedia data comprising a decoder configured to decode a plurality of first partitions belonging to a first category using an algorithm and a plurality of second partitions belonging to a second category using a texture model and a production module configured to create multimedia data using boundary information, the plurality of first partitions and the plurality of second partitions.

### BRIEF DESCRIPTION OF THE DRAWINGS

The features, objects, and advantages of the invention will become more apparent from the detailed description set forth below when taken in conjunction with the drawings, wherein:

FIG. 1 is a block diagram of a system for transmitting and receiving pictures and video frames according to an embodiment of the invention;

FIG. 2 is a block diagram of a system for transmitting and receiving pictures and video frames according to an embodiment of the invention;

FIG. 3 is a flow chart illustrating a method of encoding pictures and video frames according to an embodiment of the invention;

FIGS. 4A, 4B, and 4C are examples of an 8 connected neighborhood, a 4 connected neighborhood, and an oblique neighborhood for the definition of Markov Random Fields according to several embodiments of the invention;

FIG. 5 is a picture illustrating four different realizations of a MRF model where each realization includes a different neighborhood definition according to several embodiments of the invention;

FIG. 6 is a flow chart illustrating a method of decoding pictures and video frames according to an embodiment of the invention;

FIG. 7 is a block diagram of an apparatus for processing multimedia data according to an embodiment of the invention;

FIG. 8 is a block diagram of an apparatus for processing multimedia data according to an embodiment of the invention;

FIG. 9 is a block diagram illustrating exemplary components for the means for apparatus for processing multimedia data; and

FIG. 10 is a block diagram illustrating exemplary components for the means for apparatus for processing multimedia data.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

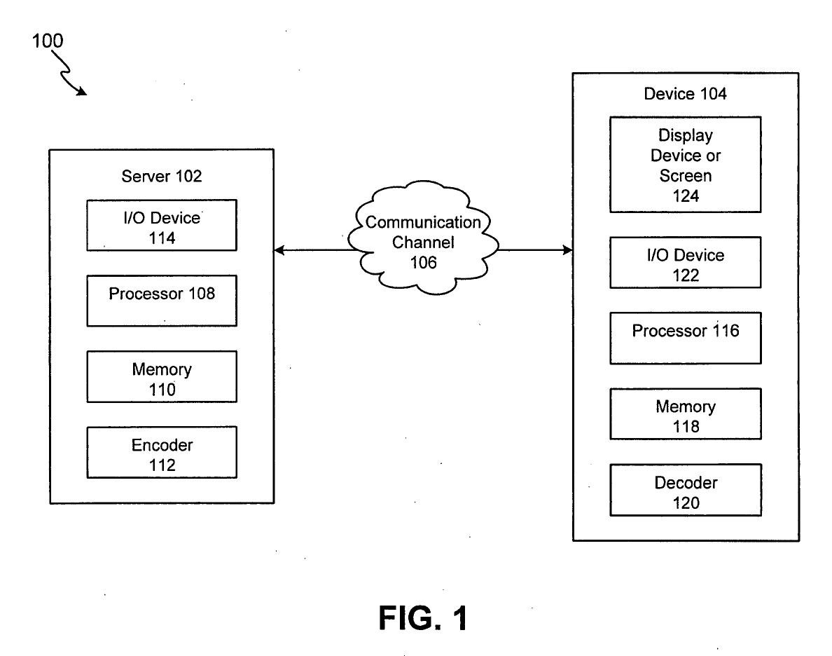

FIG. 1 is a block diagram of a system 100 for transmitting and receiving video data (e.g., pictures and video frames). The system 100 may also be used to encode (e.g., compress) and decode (e.g., decompress) pictures and video frames. The system 100 may include a server 102, a device 104, and a communication channel 106 connecting the server 102 to the device 104. The system 100 is an exemplary system used to illustrate the methods described below for encoding and decoding pictures and video frames. The system 100 may be implemented in hardware, software, and combinations thereof. One skilled in the art will appreciate that other systems can be used in place of system 100 while still maintaining the spirit and scope of the invention.

The server 102 may include a processor 108, a memory 110, an encoder 112, and an I/O device 114 (e.g., a transceiver). The server 102 may include one or more processors 108, one or more memories 110, one or more encoders 112, and one or more I/O devices 114 (e.g., a transceiver). The processor 108 and/or the encoder 112 may be configured to receive pictures and video data in the form of a series of video frames. The processor 108 and/or the encoder 112 may transmit the pictures and the series of video frames to the memory 110 for storage and/or may compress the pictures and the series of video frames. The memory 110 may also store computer instructions that are used by the processor 108 and/or the encoder 112 to control the operations and functions of the server 102. The encoder 112, using computer instructions received from the memory 110, may be configured to perform both parallel and serial processing (e.g., compression) of the series of video frames. The computer instructions may be implemented as described in the methods below. Once the series of frames are encoded, the encoded data may be sent to the I/O device 114 for transmission to the device 104 via the communication channel 106.

The device 104 may include a processor 116, a memory 118, a decoder 120, an I/O device 122 (e.g., a transceiver), and a display device or screen 124. The device 104 may include one or more processors 116, one or more memories 118, one or more decoders 120, one or more I/O devices 122 (e.g., a transceiver), and one or more display devices or screens 124. The device 104 may be a computer, a digital video recorder, a handheld device (e.g., a cell phone, Blackberry, etc.), a set top box, a television, and other devices capable of receiving, processing (e.g., decompressing) and/or displaying a series of video frames. The I/O device 122 receives the encoded data and sends the encoded data to the memory 118 and/or to the decoder 120 for decompression. The decoder 120 is configured to reproduce the pictures and/or the series of video frames using the encoded data. Once decoded, the pictures and/or the series of video frames can be stored in the memory 118. The decoder 120, using computer instructions retrieved from the memory 118, may be configured to perform both parallel and serial processing (e.g., decompression) of the encoded data to reproduce the pictures and/or the series of video frames. The computer instructions may be implemented as described in the methods below. The processor 116 may be configured to receive the pictures and/or the series of video frames from the memory 118 and/or the decoder 120 and to display the pictures and/or the series of video frames on the display device 124. The memory 118 may also store computer instructions that are used by the processor 116 and/or the decoder 120 to control the operations and functions of the device 104.

The communication channel 106 may be used to transmit the encoded data between the server 102 and the device 104. The communication channel 106 may be a wired network and/or a wireless network. For example, the communication channel 106 can include the Internet, coaxial cables, fiber optic lines, satellite links, terrestrial links, wireless links, and other media capable of propagating signals.

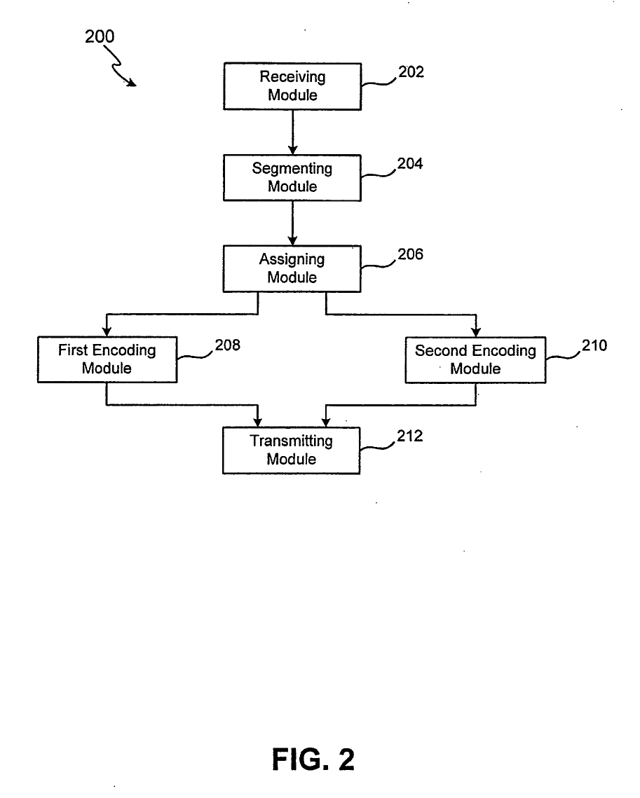

FIG. 2 is a block diagram of a system 200 for transmitting and receiving pictures and video frames. The system 200 may also be used to encode (e.g., compress) and decode (e.g., decompress) pictures and video frames. The system 200 may include a receiving module 202, a segmenting module 204, an assigning module 206, a first encoding module 208, a second encoding module 210, and a transmitting module 212. The modules shown in FIG. 2 can be part of one or more of the devices shown in FIG. 1. For example, the receiving module 202 and the transmitting module 212 can be part of the I/O devices 114 and 122. Also, the segmenting module 204, the assigning module 206, the first encoding module 208, and the second encoding module 210 can be part of the encoder 112. The system 200 is an exemplary system used to illustrate the methods described below for encoding and decoding pictures and video frames. The system 200 may be implemented in hardware, software, and combinations thereof. One skilled in the art will appreciate that other systems can be used in place of system 200 while still maintaining the spirit and scope of the invention.

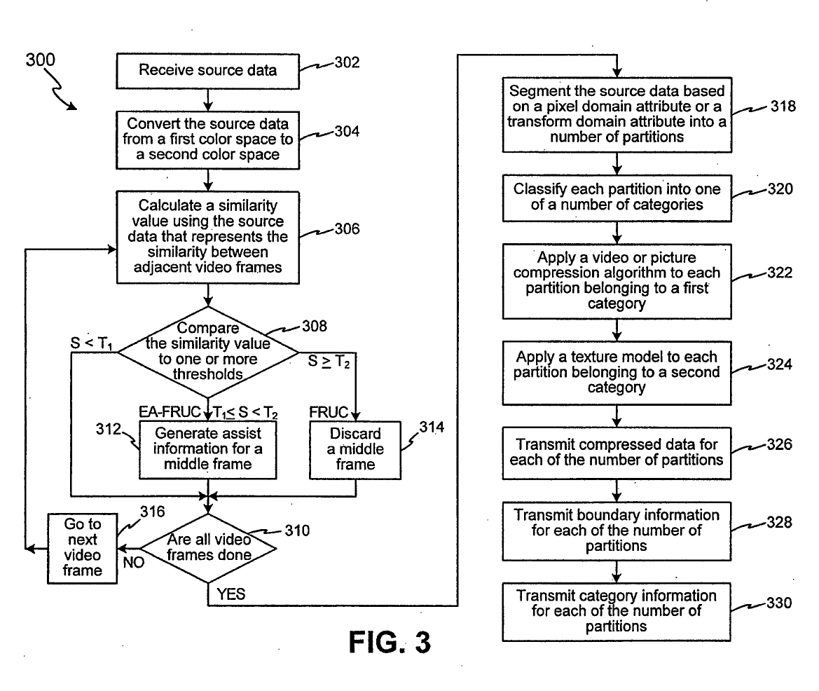

FIG. 3 is a flow chart illustrating a method 300 of encoding multimedia data (e.g., audio, video, images, etc.). The video is generally made up of a number of video frames and each picture and video frame is made up of a number of pixels. Each pixel can be represented by a number of bits (e.g., 24 bits) where, for example, 8 bits represent a red color component, 8 bits represent a green color component, and 8 bits represent a blue color component. The number of pixels used to represent each picture and/or video frame depends on the resolution (e.g., high definition) of the picture and/or video frame. The number of bits used to represent each pixel depends on the fidelity (e.g., high fidelity) of the picture or video frame. The complete set of bits used to represent one or more pictures or video frames can be referred to as the source data bits. For purposes of this disclosure, the term video frame may be used to describe a picture and/or a frame of a video.

The encoder 112 receives the source data bits (step 302) and converts the source data from a first color space (e.g., RGB) to a second color space (e.g., YUV or YCbCr) (step 304). A color space is generally made up of three color components. Several color spaces, color space conversion algorithms and matrices exist in the art to perform the conversion from the first color space to the second color space. An example of a color space conversion matrix is:

$$[ \begin{matrix}Y \\ U \\ V\end{matrix} ] = [ \begin{matrix}0.299 & 0.587 & 0.114 \\ - 0.147 & - 0.289 & 0.436 \\ 0.615 & - 0.515 & - 0.100\end{matrix} ] [ \begin{matrix}R \\ G \\ B\end{matrix} ]$$

The conversion from the first color space to the second color space allows the source data bits to be in a better form for compression.

The encoder 112 may analyze the source data to determine whether similarities or redundancies exist between adjacent video frames (step 306). The encoder 112 usually compares a video frame (sometimes referred to as a middle video frame) with its prior and subsequent video frames for similarities or redundancies. For example, frame 3 may be compared to frame 2 and frame 4 for similarities. Depending on the similarities, redundancies, and/or capabilities of the decoder 120, the encoder 112 may perform a frame rate up conversion (FRUC) or an encoder-assisted frame rate up conversion (EA-FRUC) processing on the source data bits.

The encoder 112 can calculate or produce a similarity value (S) to determine the similarity between adjacent frames. The similarity value can be computed using, for example, the Y components of pixels of the source data. The similarity value can be represented as S(Y₂,Y₃,Y₄) where Y₂ is a matrix of pixel (luminance/brightness) values belonging to a prior frame, Y₃ is a matrix of pixel (luminance/brightness) values belonging to a middle or target frame, and Y₄ is a matrix of pixel (luminance/brightness) values belonging to a subsequent frame. One example of a method of producing a similarity value is using a sum of absolute differences (SAD) algorithm. Another example of a method of producing a similarity value is using a motion compensated SAD (MCSAD) algorithm.

The similarity metric S(.) may take into account more than one prior frames such as { . . . , Y₋₁, Y₀, Y₁, Y₂} and likewise it may take into account more than one subsequent frames such as {Y₄, Y₅, Y₆, . . . }. Such multi-frame analysis (in particular in the causal direction) is more consistent with the state-of-the-art video compression technologies and may improve temporal segmentation performance and accuracy.

The similarity metric S(.) may take into account one or more or all of the color space dimensions with respect to which the video signal is represented. Such multi-dimensional analysis may improve temporal segmentation performance and accuracy.

The similarity metric S(.) may return a scalar or vector valued similarity measure. A vector valued similarity measure may have multiple scalar components. For example, in one embodiment, each of these scalar components may reflect similarity values between different pairs of frames, one typically being the current frame (middle or target frame) and the other being a frame from the prior neighbors' list or the subsequent neighbors' list. In one embodiment, the multiple scalar components of a vector valued similarity measure may reflect similarity values calculated with respect to different color space dimensions.

The sequence of similarity metric values may be processed by the encoder 112. The encoder 112 may input the sequence of values into an analysis module. The analysis module may be part of the processor 108 and/or the encoder 112. The analysis module may in general utilize a non-causal window of time-varying size to process a subset or all of the similarity metric values provided, for each frame to make (1) a temporal segmentation decision such as scene-change/shot-boundary or not, or (2) an encoding mode decision such as regular encoding, or encoder-assisted frame interpolation (EA_FRUC) or skip (decoder only frame interpolation, FRUC), or (3) both.

The analysis module may utilize a perceptual model (Human Visual System model). The analysis module may also use recursive analysis techniques implying a system with memory where the current state is a function of the history of previous inputs to the analysis module. The analysis module may also use iterative analysis techniques implying that each new frame's decision is not necessarily final but may be revisited and updated later again on the basis of new or updated understanding of similarity metric evolution. The analysis module may also apply filtering or other mappings to the similarity metric values input to it. In one embodiment, the analysis module may map similarity metric values to some dissimilarity measure.

In one embodiment, the encoder 112 may compare the similarity value to one or more thresholds (step 308). If the similarity value is less than a first threshold (T1) then the adjacent frames are not similar (go to step 310). Using the example above, frame 3 is not similar to frame 2 or 4 or both. If the similarity value is equal to or greater than the first threshold (T1) and less than a second threshold (T2) then the adjacent frames are similar (go to step 312). Using the example above, frame 3 is similar to frames 2 and 4. If the similarity value is equal to or greater than the second threshold (T2) then the adjacent frames are very similar (go to step 314). Using the example above, frame 3 is very similar to frames 2 and 4. One way the encoder 112 keeps track of the ordering or sequence of the video frames is to put a time stamp or frame number on each video frame.

In one embodiment, the encoder 112 may utilize static or dynamic (adaptive) probability models on sequences (vectors) of similarity metric values to formulate the analysis task as a formal hypothesis testing problem. This enables optimal (in a statistical sense) decision making for temporal segmentation or encoding modes. The analysis module utilized by the encoder 112 may be based on many-valued (fuzzy) logic principles rather than the common Boolean logic, with respect to the nature of its decision output. This enables higher fidelity information preservation and more accurate representation of complex (both temporally and spatially) video frame dynamics.

At step 310, the encoder 112 increments a frame counter by 1 to move to the next frame. Using the example above, the middle frame becomes frame 4.

At step 312, the encoder 112 performs an EA-FRUC. For EA-FRUC, the encoder 112 is aware of the frame interpolation algorithm running at the decoder 120. When adjacent video frames are similar, rather than sending repetitive data from adjacent video frames, the encoder 112 generates assist information for or retrieves assist information from the target frame, i.e., the middle frame (step 312). The assist information enhances the quality of and/or reduces the computational complexity of the interpolation process performed by the decoder 120. With the assist information, the encoder 112 does not have to send the data for the entire target frame, but needs to send the assist information to the decoder 120 for reconstruction of the target frame. Hence, the assist information allows the decoder 120 to recreate the target video frame with minimal data, i.e., using the assist information.

At step 314, the encoder 112 performs a FRUC triggering frame dropping operation. FRUC enables interpolation of partial or entire video frames at the device 104. When adjacent video frames are very similar, rather than sending repetitive/redundant data from adjacent video frames, the encoder 112 discards or removes the target frame from being sent to the decoder 120 (step 314). FRUC can be used for different purposes such as increasing compression efficiency through totally avoiding transmitting any data for a select subset of video frames when this is feasible or for error concealment when the compressed data for extended portions of video frames or for entire video frames are lost due to channel impairments. In either case, the device 104, using its local resources and available information from other already received frames, interpolates the (partially or fully) missing video frames. With FRUC, the device 104 receives no augmenting/auxiliary data for the video frames to be interpolated. Classification processing for EA-FRUC and FRUC is generally performed on all the video frames (steps 310 and 316).

The encoder 112 performs a scene analysis on the video frames based on one or more pixel domain attributes (e.g., one or more color channels) or transform domain attributes (e.g., block classification based on DC coefficient value and AC coefficient power in predefined subbands) to temporally or spatially segment the video frames and identify regions on the video frames that can be accurately described as textures (step 318). If the second color space (step 304) is YUV, the one color channel is preferably Y. The encoder 112 may segment the source data based on at least one color channel (i.e., color space component) into a number of partitions or regions. Each partition or region can have an arbitrary, random or specific size such as n×n pixels or m×n pixels, where m and n are integers, or an arbitrary, random or specific shape, such as a cloud or square shape. Each partition or region can have a different arbitrary, random or specific size and/or shape.

The encoder 112 may adopt a feature vector including transform domain attributes of the source data such as the DC coefficient value resulting from the Discrete Cosine Transform, DCT, of an 8×8 pixel block, and the total signal power within predefined subbands, i.e., within predefined subsets of AC coefficients resulting from the same (DCT) transform of the same 8×8 pixel block. These subbands may, for example, correspond to pure horizontal frequencies, i.e., vertical edges, pure vertical frequencies, i.e., horizontal edges, oblique edges, and more texture-like spatial frequency patterns. The encoder may calculate/generate this feature vector for each 8×8 pixel block in the source data and use a data clustering algorithm in the feature space to classify each 8×8 pixel block into one of a number of partitions or regions.

Several different segmentation algorithms (e.g., spatial and/or temporal) can be used to segment the source data. Spatial segmentation can be used for pictures and video frames and temporal segmentation can also be used for video frames. If both spatial and temporal segmentation are used for video frames, spatial segmentation is generally performed prior to temporal segmentation since results of spatial segmentation can be used as a cue for temporal segmentation.

Spatial segmentation involves dividing a picture or video frame into a number of partitions. In spatial segmentation, one partition does not overlap another partition; however, the union of all partitions covers the entire picture or video frame. In one embodiment, the segmentation involves dividing the picture or video frame into a number of arbitrarily shaped and sized partitions. Several spatial segmentation algorithms that divide a picture or video frame into a number of arbitrarily shaped and sized partitions exist in the art such as those described in C. Pantofaru and M. Hebert, “A Comparison of Image Segmentation Algorithms,” tech. report CMU-RI-TR-05-40, Robotics Institute, Camegie Mellon University, September, 2005. Also, region growing is a known spatial segmentation algorithm. In another embodiment, the segmentation may involve dividing the picture or video frame into a number of square shaped but arbitrarily sized partitions. For example, the quadtree partitioning algorithm, well known in the art of image processing, is one way of achieving this.

Temporal segmentation involves associating or grouping together one or more video frames. Several different temporal segmentation algorithms, such as scene change detection and shot boundary detection, can be used to temporally segment video frames. Scene change detection involves grouping together all video frames that are part of the same scene. Once the scene (e.g., video frames including a particular sporting event) changes, the next grouping of video frames, i.e., the next scene, begins. Shot boundary detection involves grouping together all video frames that are part of the same shot. Once the shot (e.g., video frames including a particular person) changes, the next grouping of video frames, i.e., the next shot, begins. The context determines the scene and the content determines the shot.

Segmentation schemes such as those based on three-dimensional random-field/texture models can be utilized to achieve both spatial and temporal segmentation concurrently.

Compression algorithms that support the coding of square or rectangular shaped and uniformly sized partitions commonly utilize block transform coding tools (e.g., an 8×8 discrete cosine transform (DCT) algorithm) and block-based motion compensated temporal prediction (MCTP) algorithms (e.g., the MPEG-4 video compression algorithm). The use of an 8×8 DCT algorithm has been popular for the spatial compression of visual data. The 8×8 DCT algorithm can be shown to approximate the Karhunen-Loeve Transform (KLT), which is the optimal linear transform in the mean squared error sense, for slowly varying (e.g., low detail) visual data; however, it is not very efficient for regions of a picture or video frame that involve texture. A texture can be described as a visual object which exhibits considerable detail/variation across multiple scales/resolutions. The use of a MCTP algorithm at macro-block sizes (e.g., 16×16) is good for rigid bodies or objects that experience translational motion. However, these algorithms are not adequate for non-rigid bodies (deforming bodies) or objects experiencing non-translational motion (e.g., texture in motion such as grass, flower fields, or tree branches with leaves) because their deformation and non-translational movement make it difficult to match features from one frame to another frame. Also, texture details and boundaries are not generally formed in the shape of rectangles. Therefore, these compression tools are popular but are not very good at compressing textures.

After the encoder 112 segments the source data into a number of partitions, each of the partitions is classified into one of a number of categories (step 320). In one embodiment, the number of categories is two, which includes a first category such as a hybrid (i.e., transform coding and MCTP based) coding category and a second category such as a texture coding category. The classification can be based on whether or not each particular partition includes texture. If the partition does not include texture, then the partition is classified into the first category. If the partition includes texture, then the partition is classified into the second category. One reason to distinguish between partitions that include texture and partitions that do not include texture is because certain algorithms are good at compressing texture through the use of parameterized models, and certain algorithms are not good at compressing texture. For example, texture modeling algorithms are good at compressing textures while general video or picture compression algorithms are not good at compressing textures but are good at compressing non-textures objects or images (steps 322 and 324). Therefore, it is inefficient and not practical to compress all partitions using the same algorithm. Better overall compression is achieved by classifying each partition based on whether or not texture is present in the partition.

Several different methods can be used to determine whether a particular partition includes texture. One exemplary method involves the encoder 112 applying a compression algorithm (e.g., a hybrid coding algorithm) to each of the partitions to determine whether the compression of the partition produces a desirable quality and bit rate operation point. That is, if (a) the bit rate is less than a bit rate threshold and (b) the quality is greater than a quality threshold, then the partition is classified into the first category. If either (a) or (b) is not met, then the partition is classified into the second category.

In another embodiment, if either (a) or (b) is not met, then the partition's content is evaluated for ‘relevance’ of its original detail. As a result of the ‘relevance’ analysis, if the partition, although it better fits to be considered as a texture, is concluded to convey significant information in its original detail, i.e., ‘relevant’, then it is classified into the first category. Otherwise, if the partition is concluded not to convey significant information in its original detail, i.e., ‘irrelevant’, then it is classified into the second category.

The bit rate threshold is a function of multiple factors such as source format (i.e., frame size and frame rate), type of application, content of the partition or frame, and (relative) size of the partition. In one embodiment, the bit rate threshold may be different for each partition or frame. The frame size depends on the spatial resolution of the image i.e., how many pixels per row and how many pixel rows exist in a frame. For example, the image may be in standard definition (SD, e.g., 720×486), high definition (HD, e.g., 1920×1080), video graphics array (VGA, e.g., 640×480), quarter VGA (QVGA, e.g., 320×240), etc. The type of application can be broadcast television, streaming video for mobile devices, streaming video over the Internet, etc. The content of the partition or frame is the determining factor of the complexity of the visual data in the partition or frame.

The quality threshold can be defined with respect to a subjective quality metric or an objective quality metric.

The subjective quality metric is a measure of the perceived quality which can be determined through different physcovisual tests. The subjective quality threshold can be set to, for example, a Mean Opinion Score (MOS) of 4.0 on a perceptive quality scale of 1 to 5 (with typical interpretation 1: “very annoying”/“bad”, 2: “annoying”/“poor”, 3: “slightly annoying”/“fair”, 4: “perceptible but not annoying”/“good”, 5: “imperceptible”/“excellent”).

The objective quality metric may be derived using a number of different methods. One method of obtaining an objective quality metric is to determine a peak signal-to-noise ratio (PSNR) of one of the channels (e.g., the Y channel) for a particular partition or frame. The orig(i,j) represents the original image data (i.e., the original pixel value at the ith column and the jth row) and the comp(i,j) represents the compressed image data (i.e., the pixel value after compression at the ith column and the jth row). The PSNR can be determined using the following equation.

$${PSNR}_{Y} = 20 {log}_{10} [ \frac{{255}^{2}}{\frac{1}{row count \times column count} \times {\sum }_{j = 1}^{cc} {\sum }_{i = 1}^{rc} {( {orig}_{Y} ( i , j ) - {comp}_{Y} ( i , j ) )}^{2}} ]$$

Then, the quality threshold can be set to, for example, 33 dB. In this example, if the quality (i.e., PSNR_{Y}) is greater than 33 dB, then the compressed image has a satisfactory/good quality.

Other objective metrics can be reference-based, reduced reference-based, or no-reference quantities combining deterministic or statistical measures targeting the quantification of blur, blockiness, ringing and other distortions which relate to and influence the similarity metrics used.

If the partition is classified into the first category, then the partition content is compressed or described using a video or picture compression algorithm or model (e.g., a hybrid coding algorithm) that provides good compression results for non-textured objects and images (step 322).

If the partition is classified into the second category, then the partition is compressed or described using an algorithm or model (e.g., a texture model) that provides good analysis and synthesis results for textured objects and regions (step 324). The algorithm or model may include one or more of the following: transform coding, spatial coding and temporal coding. For partitions classified into the second category, compression is achieved through lossless (exact) or lossy (approximate) representation and transmission of the model parameters. A texture model is a probabilistic mathematical model which is used to generate two dimensional random fields. The exact probabilistic nature of the output of such a model depends on the values of parameters which govern the model. Starting from a given two dimensional random field sample, using its data it is possible to estimate the parameter values of a texture model in an effort to tune the model to generate two dimensional random fields which look similar to the given sample. This parameter estimation process is known as model fitting.

Texture model based coding allows the number of bits required to satisfactorily represent textures, to be reduced greatly while still being able to reproduce a visually very similar texture. Texture models are mathematical tools capable of describing and producing textures. Some examples of texture models include Markov Random Fields (MRF), Gibbs Random Fields (GRF), Cellular Automata, and Fractals. The MRF provide a flexible and useful texture model and may be described to illustrate a texture model based coding.

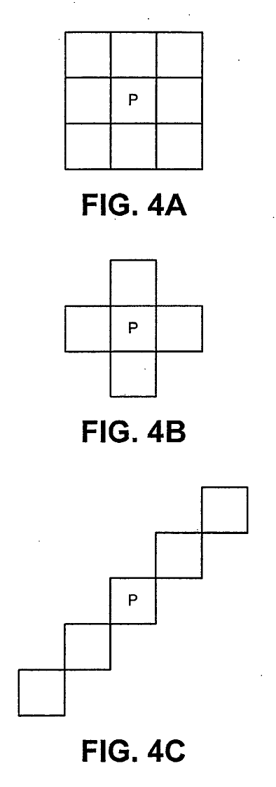

In MRF models, the probabilistic nature of each pixel is determined or influenced by the states of its neighboring pixels where the neighborhood N constitutes a tunable parameter of the model. The MRF models include a number of different tunable/adjustable parameters that control the strength, consistency, and direction of the clustering (i.e., grouping of similar brightness and colors) in the resulting image. For example, P is a set of sites or pixel locations, N is a neighborhood, Nₚ is the corresponding neighborhood of pixel p, F is a set of random variables defined at the sites representing pixel values, and Fₚ is a random variable defined at the position of pixel p. Examples of the neighborhood N include an 8 connected neighborhood (FIG. 4A), a 4 connected neighborhood (FIG. 4B), and an oblique neighborhood (FIG. 4C).

The Markov property, which gives this particular model its name, implies that P(Fₚ=f|F(P\{p}))=P(Fₚ=f|F(Nₚ)). In this equation, P denotes the probability measure and \ denotes the set difference operation. In other words, with respect to the probabilistic characterization of the pixel p, knowledge of the neighboring pixel values within the Nₚ neighborhood of pixel p, is statistically equivalent to the knowledge of all pixel values within the entire set of sites P except for the pixel p.

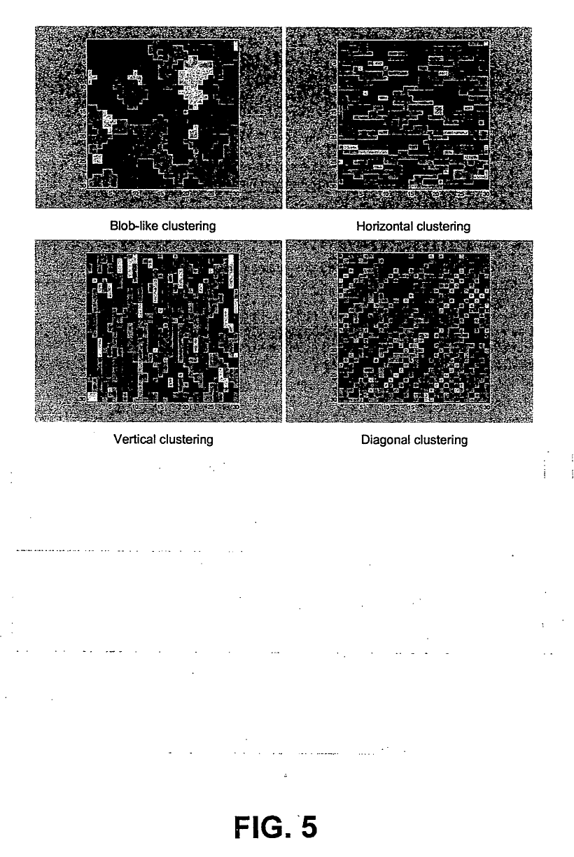

FIG. 5 is a picture illustrating four different realizations of a MRF model where each realization corresponds to a different neighborhood definition. MRF models can describe and generate a wide range of textures such as blurry or sharp, line-like, or blob-like random fields. The textures can be analyzed to determine or estimate their parameters for the MRF models.

Referring back to FIGS. 1 and 3, once the compression of the contents of the partitions is complete, the processor 108, using the I/O device 114, transmits compressed data corresponding to each of the partitions (step 326) and boundary information for each of the partitions (step 328) to the device 104. The compressed data is the source data after a compression algorithm or a parameterized model has been applied and in the latter case, parameters estimated and exactly or approximately represented. The boundary information includes information that is used to define the boundary for each of the number of partitions. For rectangular shaped and arbitrarily sized partitions, the boundary information includes the coordinates of the top left corner and the bottom right corner of each rectangle. Another example for conveying rectangular (square) shaped and arbitrarily sized partitions is the use of a quadtree representation. For arbitrarily shaped and arbitrarily sized partitions, the boundary information can be determined and represented by using, for example, Shipeng Li (Microsoft Research, China) and Iraj Sodagar (Sarnoff Corporation), “Generic, Scalable and Efficient Shape Coding for Visual Texture Objects in MPEG-4.”

The processor 108, using the I/O device 114, transmits category information for each of the number of partitions to the device 104 (step 330). In the example above, the processor 108 may indicate that the particular partition belongs to the first category or the second category. The category information may also include the type of algorithm or model (e.g., hybrid coding algorithm or texture model) and the parameters for the model.

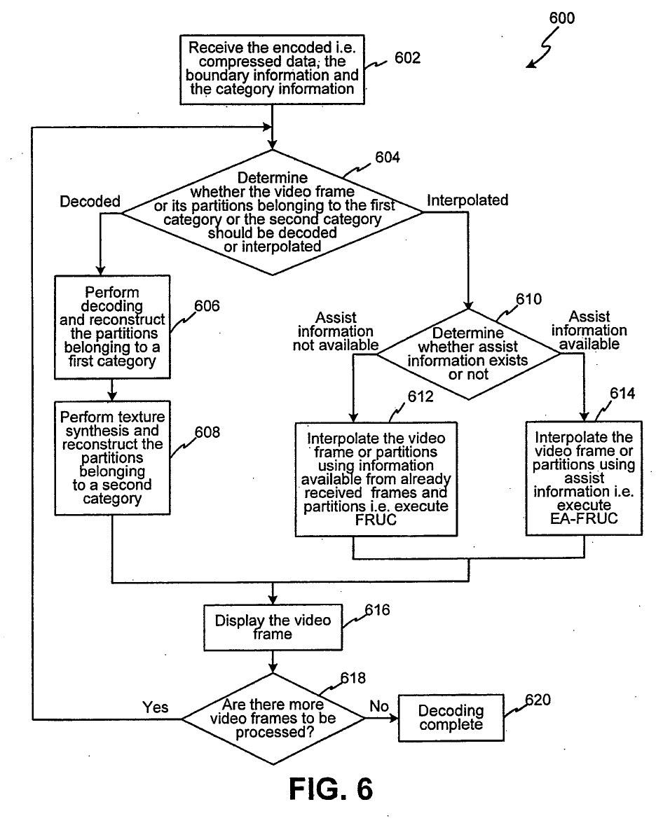

FIG. 6 is a flow chart illustrating a method 600 of decoding pictures and video frames. The device 104 receives the encoded/compressed data, the boundary information, and the category information for each of the partitions (step 602). The encoded/compressed data may include assist information for video frames and/or partitions belonging to a first category or a second category. The decoder 120 determines whether each video frame or partition belonging to the first category or the second category should be decoded or interpolated (step 604).

If the video frame or partition belonging to the first category or the second category is to be decoded then the decoder proceeds as follows. The decoder 120 decodes the encoded data and reconstructs each partition in the first category using the decoded data, the boundary information, and the category information (step 606). The decoder 120 performs texture synthesis and reconstructs each partition belonging to the second category using the decoded data, the boundary information, and the category information (step 608).

If the video frame or partition belonging to the first category or the second category is to be interpolated then the decoder proceeds as follows. The decoder 120 determines if assist information is available for the video frame or partition belonging to the first category or the second category which is to be interpolated (step 610). If assist information is not available, the decoder 120 can use FRUC to efficiently (i.e., with low computational complexity and high objective and subjective quality) interpolate the compressed source data using the already received and processed, i.e., decoded, compressed data, boundary information and category information (step 612). In one embodiment, all inferred partitions belonging to the first category or second category in a totally missing frame or within the missing region of a partially available frame, are interpolated. Interpolation schemes based on hybrid coding representations are known in the art, for example, are described in R. Castagno, P. Haavisto, and G. Ramponi, “A Method for Motion Adaptive Frame Rate Up-conversion,” IEEE Transactions on Circuits and Systems for Video Technology, Volume 6, Issue 5, October 1996, Page(s) 436-446. If assist information is available, the decoder 120 can use EA-FRUC to efficiently (i.e., with low computational complexity and high objective and subjective quality) interpolate the compressed source data using the already received and processed, i.e., decoded, compressed data, boundary information, category information and assist information (step 614).

Once the decoding and/or interpolation is performed, the processor 116 can display the video frame (step 616). The processor 116 or the decoder 120 checks to see if there is more picture or video frame data to be processed (step 618). If there is more picture or video frame data to be processed, the decoder 120 loops back to the beginning of the process for decoding or interpolating and displaying a picture or a video frame (step 604). Otherwise, the current decoding task is finished (step 620).

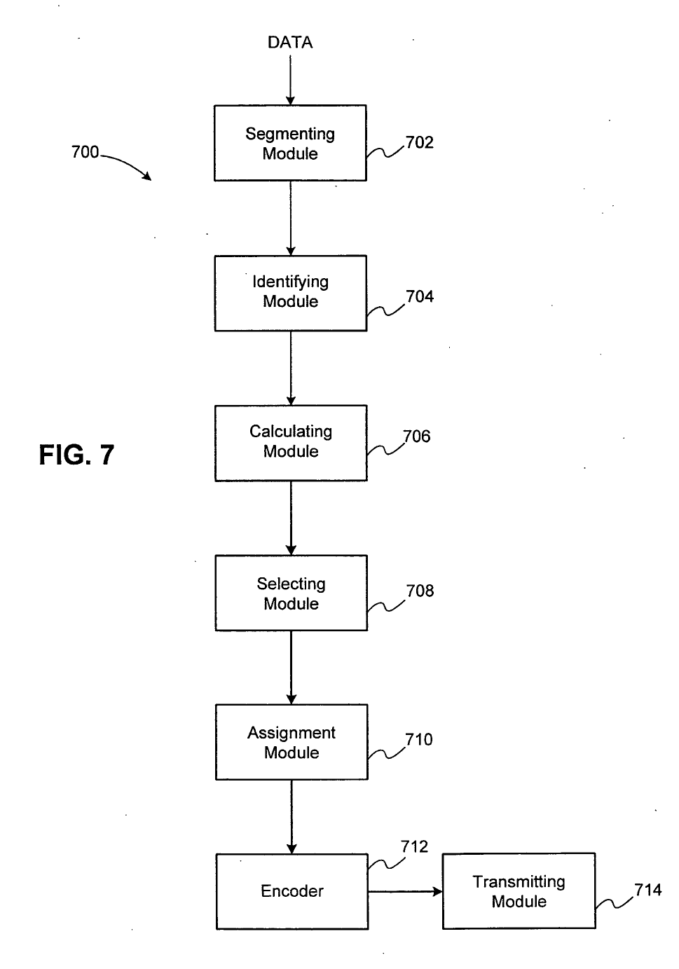

FIG. 7 is a block diagram of an apparatus 700 for processing multimedia data. The apparatus 700 may include a segmenting module 702 configured to segment data into a plurality of partitions, an identifying module 704 configured to identify the plurality of partitions that can be represented as textures, a calculating module 706 configured to calculate a similarity value between at least two partitions of adjacent video frames and a selecting module 708 configured to select a partition to encode based on the similarity value. The apparatus 700 may also include an assignment module 710 configured to assign each of the plurality of partitions to one of a plurality of categories comprising a first category and a second category, one or more encoders 712 configured to encode the plurality of partitions assigned to the first category using an algorithm and the plurality of partitions assigned to the second category using a texture model and a transmitting module 714 configured to transmit encoded data, boundary information and category information associated with the plurality of partitions. One or more modules may be added or deleted depending on the configuration of the apparatus 700. Each module may be implemented using hardware, software or combinations thereof. The means for segmenting, identifying, calculating, selecting, assigning, encoding and transmitting may be implemented using hardware, software or combinations thereof. For example, the means may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein.

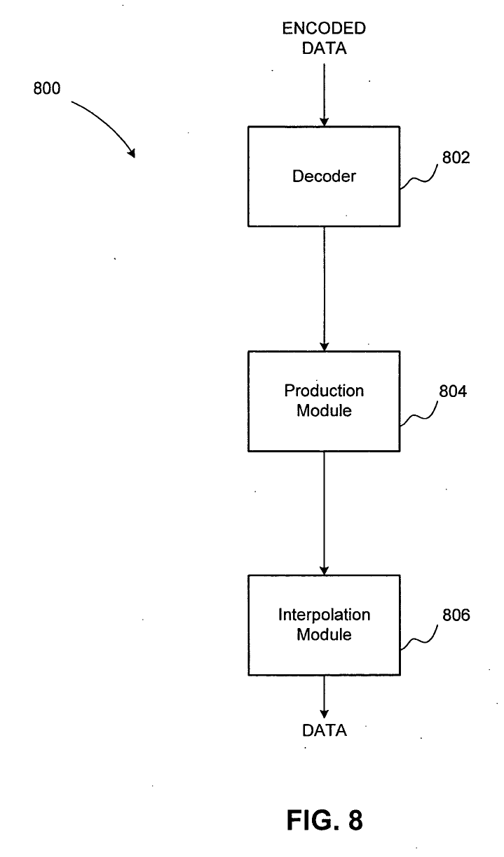

FIG. 8 is a block diagram of an apparatus 800 for processing multimedia data. The apparatus 800 may include a decoder 802 configured to decode a plurality of first partitions belonging to a first category using an algorithm and a plurality of second partitions belonging to a second category using a texture model, a production module 804 configured to create multimedia data using boundary information, the plurality of first partitions and the plurality of second partitions and an interpolation module 806 configured to interpolate the multimedia data to produce interpolated multimedia data. The means for decoding, creating and interpolating may be implemented using hardware, software or combinations thereof. For example, the means may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein.

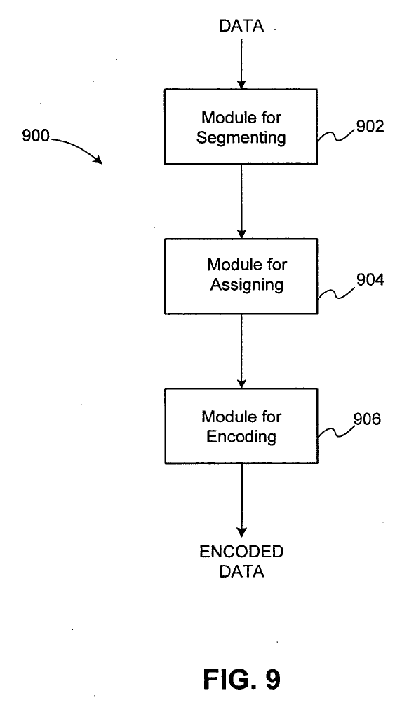

FIG. 9 is a block diagram 900 illustrating exemplary components for the means for apparatus for processing multimedia data. One or more modules shown in FIG. 9 may be used as the components for the means for segmenting, assigning and encoding. The modules may be implemented using hardware, software or combinations thereof. One or more modules may be added or deleted depending on the configuration of the apparatus 900. For example, the means may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, software modules or any combination thereof designed to perform the functions described herein.

The apparatus 900 may include a module for segmenting 902 configured to segment data into a plurality of partitions, a module for assigning 904 configured to assign each of the plurality of partitions to one of a plurality of categories comprising a first category and a second category and a module for encoding 906 configured to encode the plurality of partitions assigned to the first category using an algorithm and the plurality of partitions assigned to the second category using a texture model.

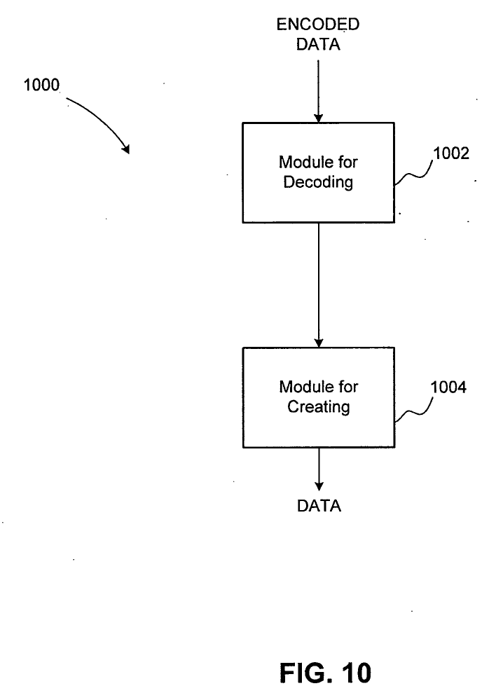

FIG. 10 is a block diagram illustrating exemplary components for the means for apparatus for processing multimedia data. One or more modules shown in FIG. 10 may be used as the components for the means for decoding and creating. The modules may be implemented using hardware, software or combinations thereof. One or more modules may be added or deleted depending on the configuration of the apparatus 1000. For example, the means may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, software modules or any combination thereof designed to perform the functions described herein.

The apparatus 1000 may include a module for decoding 1002 configured to decode a plurality of first partitions belonging to a first category using an algorithm and a plurality of second partitions belonging to a second category using a texture model and a module for creating 1004 configured to create multimedia data using boundary information, the plurality of first partitions and the plurality of second partitions.

Those skilled in the art will appreciate that the various illustrative logical blocks, modules, circuits, and algorithms described in connection with the embodiments disclosed herein may be implemented as electronic hardware, computer software, or combinations of both. To illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processing device, a digital signal processing device (DSP), an application specific integrated circuit (ASIC), a field programmable gate array (FPGA) or other programmable logic device, discrete gate or transistor logic, discrete hardware components, or any combination thereof designed to perform the functions described herein. A general purpose processing device may be a microprocessing device, but in the alternative, the processing device may be any conventional processing device, processing device, microprocessing device, or state machine. A processing device may also be implemented as a combination of computing devices, e.g., a combination of a DSP and a microprocessing device, a plurality of microprocessing devices, one or more microprocessing devices in conjunction with a DSP core or any other such configuration.

The apparatus, methods or algorithms described in connection with the embodiments disclosed herein may be embodied directly in hardware, software, or combination thereof. In software the methods or algorithms may be embodied in one or more instructions that may be executed by a processing device. The instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processing device such the processing device can read information from, and write information to, the storage medium. In the alternative, the storage medium may be integral to the processing device. The processing device and the storage medium may reside in an ASIC. The ASIC may reside in a user terminal. In the alternative, the processing device and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A method of processing multimedia data comprising:
segmenting data into a plurality of partitions;
assigning each of the plurality of partitions to one of a plurality of categories comprising a first category and a second category;
encoding the plurality of partitions assigned to the first category using an algorithm; and
encoding the plurality of partitions assigned to the second category using a texture model.

2. The method of claim 1 further comprising transmitting encoded data, boundary information and category information associated with the plurality of partitions.

3. The method of claim 1 wherein segmenting comprises spatially segmenting, temporally segmenting or both spatially and temporally segmenting the data.

4. The method of claim 1 further comprising identifying the plurality of partitions that can be represented as textures.

5. The method of claim 1 wherein assigning each of the plurality of partitions to one of a plurality of categories is based on whether the partition comprises texture.

6. The method of claim 1 wherein assigning each of the plurality of partitions to one of a plurality of categories comprises:
applying an algorithm to at least one of the plurality of partitions to produce resulting data;
assigning the at least one of the plurality of partitions to the first category if the resulting data satisfies a first criterion; and
assigning the at least one of the plurality of partitions to the second category if the resulting data satisfies a second criterion.

7. The method of claim 6 wherein the first criterion is satisfied if the resulting data meets at least one of a quality criterion and a bit rate criterion and the second criterion is satisfied if the resulting data does not meet the at least one of the quality criterion and the bit rate criterion.

8. The method of claim 1 wherein each of the plurality of partitions has an arbitrary shape or an arbitrary size.

9. The method of claim 1 wherein encoding the plurality of partitions assigned to the first category comprises transform coding or hybrid coding.

10. The method of claim 1 wherein encoding the plurality of partitions assigned to the second category comprises fitting the texture model to the data of the plurality of partitions.

11. The method of claim 1 wherein the texture model is associated with at least one of Markov random fields, Gibbs random fields, Cellular Automata and Fractals.

12. The method of claim 1 further comprising:
calculating a similarity value between at least two partitions of adjacent video frames;
selecting a partition to encode based on the similarity value; and
encoding the selected partition by using at least one of the algorithm and the texture model based on whether the selected partition has been assigned to the first category or the second category.

13. The method of claim 12 wherein calculating a similarity value comprises using at least one of a sum of absolute differences algorithm, a sum of squared differences algorithm and a motion compensated algorithm.

14. An apparatus for processing multimedia data comprising:
a segmenting module configured to segment data into a plurality of partitions;
an assignment module configured to assign each of the plurality of partitions to one of a plurality of categories comprising a first category and a second category; and
an encoder configured to encode the plurality of partitions assigned to the first category using an algorithm and the plurality of partitions assigned to the second category using a texture model.

15. The apparatus of claim 14 further comprising a transmitting module configured to transmit encoded data, boundary information and category information associated with the plurality of partitions.

16. The apparatus of claim 14 wherein segmenting data comprises spatially segmenting, temporally segmenting or both spatially and temporally segmenting the data.

17. The apparatus of claim 14 further comprising an identifying module configured to identify the plurality of partitions that can be represented as textures.

18. The apparatus of claim 14 wherein assigning each of the plurality of partitions to one of a plurality of categories is based on whether the partition comprises texture.

19. The apparatus of claim 14 wherein assigning each of the plurality of partitions to one of a plurality of categories comprises:
an applying module configured to apply an algorithm to at least one of the plurality of partitions to produce resulting data; and
an assigning module configured to assign the at least one of the plurality of partitions to the first category if the resulting data satisfies a first criterion and the at least one of the plurality of partitions to the second category if the resulting data satisfies a second criterion.

20. The apparatus of claim 19 wherein the first criterion is satisfied if the resulting data meets at least one of a quality criterion and a bit rate criterion and the second criterion is satisfied if the resulting data does not meet the at least one of the quality criterion and the bit rate criterion.

21. The apparatus of claim 14 wherein each of the plurality of partitions has an arbitrary shape or an arbitrary size.

22. The apparatus of claim 14 wherein encoding the plurality of partitions assigned to the first category comprises transform coding or hybrid coding.

23. The apparatus of claim 14 wherein encoding the plurality of partitions assigned to the second category comprises fitting the texture model to the data of the plurality of partitions.

24. The apparatus of claim 14 wherein the texture model is associated with at least one of Markov random fields, Gibbs random fields, Cellular Automata and Fractals.

25. The apparatus of claim 14 further comprising:
a calculating module configured to calculate a similarity value between at least two partitions of adjacent video frames; and
a selecting module configured to select a partition to encode based on the similarity value,
wherein the encoder is configured to encode the selected partition by using at least one of the algorithm and the texture model based on whether the selected partition has been assigned to the first category or the second category.

26. The apparatus of claim 25 wherein calculating a similarity value comprises using at least one of a sum of absolute differences algorithm, a sum of squared differences algorithm and a motion compensated algorithm.

27. An apparatus for processing multimedia data comprising:
means for segmenting data into a plurality of partitions;
means for assigning each of the plurality of partitions to one of a plurality of categories comprising a first category and a second category; and
means for encoding the plurality of partitions assigned to the first category using an algorithm and the plurality of partitions assigned to the second category using a texture model.

28. The apparatus of claim 27 further comprising means for transmitting encoded data, boundary information and category information associated with the plurality of partitions.

29. The apparatus of claim 27 wherein the means for segmenting comprises spatially segmenting, temporally segmenting or both spatially and temporally segmenting the data.

30. The apparatus of claim 27 further comprising means for identifying the plurality of partitions that can be represented as textures.

31. The apparatus of claim 27 wherein the means for assigning each of the plurality of partitions to one of a plurality of categories is based on whether the partition comprises texture.

32. The apparatus of claim 27 wherein the means for assigning each of the plurality of partitions to one of a plurality of categories comprises:
means for applying an algorithm to at least one of the plurality of partitions to produce resulting data; and
means for assigning the at least one of the plurality of partitions to the first category if the resulting data satisfies a first criterion and the at least one of the plurality of partitions to the second category if the resulting data satisfies a second criterion.

33. The apparatus of claim 32 wherein the first criterion is satisfied if the resulting data meets at least one of a quality criterion and a bit rate criterion and the second criterion is satisfied if the resulting data does not meet the at least one of the quality criterion and the bit rate criterion.

34. The apparatus of claim 27 wherein each of the plurality of partitions has an arbitrary shape or an arbitrary size.

35. The apparatus of claim 27 wherein the means for encoding the plurality of partitions assigned to the first category comprises transform coding or hybrid coding.

36. The apparatus of claim 27 wherein the means for encoding the plurality of partitions assigned to the second category comprises fitting the texture model to the data of the plurality of partitions.

37. The apparatus of claim 27 wherein the texture model is associated with at least one of Markov random fields, Gibbs random fields, Cellular Automata and Fractals.

38. The apparatus of claim 27 further comprising:
means for calculating a similarity value between at least two partitions of adjacent video frames;
means for selecting a partition to encode based on the similarity value; and
means for encoding the selected partition by using at least one of the algorithm and the texture model based on whether the selected partition has been assigned to the first category or the second category.

39. The apparatus of claim 38 wherein the means for calculating a similarity value comprises using at least one of a sum of absolute differences algorithm, a sum of squared differences algorithm and a motion compensated algorithm.

40. A machine-readable medium comprising instructions that upon execution cause a machine to:
segment data into a plurality of partitions;
assign each of the plurality of partitions to one of a plurality of categories comprising a first category and a second category;
encode the plurality of partitions assigned to the first category using an algorithm; and
encode the plurality of partitions assigned to the second category using a texture model.

41. The machine-readable medium of claim 40 wherein the instructions transmit encoded data, boundary information and category information associated with the plurality of partitions.

42. The machine-readable medium of claim 40 wherein the instructions spatially segment, temporally segment or both spatially and temporally segment the data.

43. The machine-readable medium of claim 40 wherein the instructions identify the plurality of partitions that can be represented as textures.

44. The machine-readable medium of claim 40 wherein the instructions that assign each of the plurality of partitions to one of a plurality of categories is based on whether the partition comprises texture.

45. The machine-readable medium of claim 40 wherein the instructions that assign each of the plurality of partitions to one of a plurality of categories comprises:
apply an algorithm to at least one of the plurality of partitions to produce resulting data;
assign the at least one of the plurality of partitions to the first category if the resulting data satisfies a first criterion; and
assign the at least one of the plurality of partitions to the second category if the resulting data satisfies a second criterion.

46. The machine-readable medium of claim 45 wherein the first criterion is satisfied if the resulting data meets at least one of a quality criterion and a bit rate criterion and the second criterion is satisfied if the resulting data does not meet the at least one of the quality criterion and the bit rate criterion.

47. The machine-readable medium of claim 40 wherein each of the plurality of partitions has an arbitrary shape or an arbitrary size.

48. The machine-readable medium of claim 40 wherein the instructions that encode the plurality of partitions assigned to the first category comprises transform coding or hybrid coding.

49. The machine-readable medium of claim 40 wherein the instructions that encode the plurality of partitions assigned to the second category comprises fitting the texture model to the data of the plurality of partitions.

50. The machine-readable medium of claim 40 wherein the texture model is associated with at least one of Markov random fields, Gibbs random fields, Cellular Automata and Fractals.

51. The machine-readable medium of claim 40 further comprising instructions that:
calculate a similarity value between at least two partitions of adjacent video frames;
select a partition to encode based on the similarity value; and
encode the selected partition by using at least one of the algorithm and the texture model based on whether the selected partition has been assigned to the first category or the second category.

52. The machine-readable medium of claim 51 wherein the instructions that calculate a similarity value comprises using at least one of a sum of absolute differences algorithm, a sum of squared differences algorithm and a motion compensated algorithm.

53. A processor for processing multimedia data, the processor being configured to:
segment data into a plurality of partitions;
assign each of the plurality of partitions to one of a plurality of categories comprising a first category and a second category; and
encode the plurality of partitions assigned to the first category using an algorithm and the plurality of partitions assigned to the second category using a texture model.

54. The processor of claim 53 further configured to transmit encoded data, boundary information and category information associated with the plurality of partitions.

55. The processor of claim 53 wherein segmenting comprises spatially segmenting, temporally segmenting or both spatially and temporally segmenting the data.

56. The processor of claim 53 further configured to identify the plurality of partitions that can be represented as textures.

57. The processor of claim 53 wherein assigning each of the plurality of partitions to one of a plurality of categories is based on whether the partition comprises texture.

58. The processor of claim 53 wherein assigning each of the plurality of partitions to one of a plurality of categories comprises:
applying an algorithm to at least one of the plurality of partitions to produce resulting data; and
assigning the at least one of the plurality of partitions to the first category if the resulting data satisfies a first criterion and the at least one of the plurality of partitions to the second category if the resulting data satisfies a second criterion.

59. The processor of claim 58 wherein the first criterion is satisfied if the resulting data meets at least one of a quality criterion and a bit rate criterion and the second criterion is satisfied if the resulting data does not meet the at least one of the quality criterion and the bit rate criterion.

60. The processor of claim 53 wherein each of the plurality of partitions has an arbitrary shape or an arbitrary size.

61. The processor of claim 53 wherein encoding the plurality of partitions assigned to the first category comprises transform coding or hybrid coding.

62. The processor of claim 53 wherein encoding the plurality of partitions assigned to the second category comprises fitting the texture model to the data of the plurality of partitions.

63. The processor of claim 53 wherein the texture model is associated with at least one of Markov random fields, Gibbs random fields, Cellular Automata and Fractals.

64. The processor of claim 53 further configured to:
calculate a similarity value between at least two partitions of adjacent video frames;
select a partition to encode based on the similarity value; and
encode the selected partition by using at least one of the algorithm and the texture model based on whether the selected partition has been assigned to the first category or the second category.

65. The processor of claim 64 wherein calculating a similarity value comprises using at least one of a sum of absolute differences algorithm, a sum of squared differences algorithm and a motion compensated algorithm.

66. A method of processing multimedia data comprising:
decoding a plurality of first partitions belonging to a first category using an algorithm;
decoding a plurality of second partitions belonging to a second category using a texture model; and
creating multimedia data using boundary information, the plurality of first partitions and the plurality of second partitions.

67. The method of claim 66 further comprising interpolating the multimedia data to produce interpolated multimedia data.

68. The method of claim 66 further comprising interpolating the plurality of first partitions to produce a plurality of interpolated first partitions and the plurality of second partitions to produce a plurality of interpolated second partitions.

69. The method of claim 66 wherein decoding the plurality of first partitions belonging to the first category comprises transform coding or hybrid coding.

70. The method of claim 66 wherein the texture model is associated with at least one of Markov random fields, Gibbs random fields, Cellular Automata and Fractals.

71. An apparatus for processing multimedia data comprising:
a decoder configured to decode a plurality of first partitions belonging to a first category using an algorithm and a plurality of second partitions belonging to a second category using a texture model; and
a production module configured to create multimedia data using boundary information, the plurality of first partitions and the plurality of second partitions.

72. The apparatus of claim 71 further comprising an interpolation module configured to interpolate the multimedia data to produce interpolated multimedia data.

73. The apparatus of claim 71 further comprising an interpolation module configured to interpolate the plurality of first partitions to produce a plurality of interpolated first partitions and the plurality of second partitions to produce a plurality of interpolated second partitions.

74. The apparatus of claim 71 wherein decoding the plurality of first partitions belonging to the first category comprises transform coding or hybrid coding.

75. The apparatus of claim 71 wherein the texture model is associated with at least one of Markov random fields, Gibbs random fields, Cellular Automata and Fractals.

76. A machine-readable medium comprising instructions that upon execution cause a machine to:
decode a plurality of first partitions belonging to a first category using an algorithm;
decode a plurality of second partitions belonging to a second category using a texture model; and
create multimedia data using boundary information, the plurality of first partitions and the plurality of second partitions.

77. The machine-readable medium of claim 76 wherein the instructions interpolate the multimedia data to produce interpolated multimedia data.

78. The machine-readable medium of claim 76 wherein the instructions interpolate the plurality of first partitions to produce a plurality of interpolated first partitions and the plurality of second partitions to produce a plurality of interpolated second partitions.

79. The machine-readable medium of claim 76 wherein the instructions that decode the plurality of first partitions belonging to the first category comprises transform coding or hybrid coding.

80. The machine-readable medium of claim 76 wherein the texture model is associated with at least one of Markov random fields, Gibbs random fields, Cellular Automata and Fractals.

81. An apparatus for processing multimedia data comprising:
means for decoding a plurality of first partitions belonging to a first category using an algorithm and a plurality of second partitions belonging to a second category using a texture model; and
means for creating multimedia data using boundary information, the plurality of first partitions and the plurality of second partitions.

82. The apparatus of claim 81 further comprising means for interpolating the multimedia data to produce interpolated multimedia data.

83. The apparatus of claim 81 further comprising means for interpolating the plurality of first partitions to produce a plurality of interpolated first partitions and the plurality of second partitions to produce a plurality of interpolated second partitions.

84. The apparatus of claim 81 wherein the means for decoding the plurality of first partitions belonging to the first category comprises transform coding or hybrid coding.

85. The apparatus of claim 81 wherein the texture model is associated with at least one of Markov random fields, Gibbs random fields, Cellular Automata and Fractals.

86. A processor for processing multimedia data, the processor being configured to:
decode a plurality of first partitions belonging to a first category using an algorithm and a plurality of second partitions belonging to a second category using a texture model; and
create multimedia data using boundary information, the plurality of first partitions and the plurality of second partitions.

87. The processor of claim 86 further configured to interpolate the multimedia data to produce interpolated multimedia data.

88. The processor of claim 86 further configured to interpolate the plurality of first partitions to produce a plurality of interpolated first partitions and the plurality of second partitions to produce a plurality of interpolated second partitions.

89. The processor of claim 86 wherein decoding the plurality of first partitions belonging to the first category comprises transform coding or hybrid coding.

90. The processor of claim 86 wherein the texture model is associated with at least one of Markov random fields, Gibbs random fields, Cellular Automata and Fractals.
